(19) United States
(12) Patent Application Publication
(10) Pub. No.: US 2008/0229011 A1
(43) Pub. Date: Sep. 18, 2008

(54) CACHE MEMORY UNIT AND PROCESSING APPARATUS HAVING CACHE MEMORY UNIT, INFORMATION PROCESSING APPARATUS AND CONTROL METHOD

(75) Inventors: Iwao YAMAZAKI, Kawasaki (JP); Tsuyoshi Motokurumada, Kawasaki (JP); Hitoshi Sakurai, Kawasaki (JP); Hiroyuki Kojima, Kawasaki (JP); Tomoyuki Okawa, Kawasaki (JP)

Correspondence Address: STAAS & HALSEY LLP, SUITE 700, 1201 NEW YORK AVENUE, N.W., WASHINGTON, DC, 20005, US

(73) Assignee: FUJITSU LIMITED, Kawasaki (JP)

(21) Appl. No.: 12/048,585

(22) Filed: Mar. 14, 2008

(30) Foreign Application Priority Data
Mar. 16, 2007 (JP) 2007-69612

(51) Int. Cl. G06F 12/00

(52) U.S. Cl. 711/113; 711/E12.001

(57) ABSTRACT

A cache memory unit connecting to a main memory system having a cache memory area in which, if memory data that the main memory system has is registered therewith, the registered memory data is accessed by a memory access instruction that accesses the main memory system and a local memory area with which local data to be used by the processing section is registered and in which the registered local data is accessed by a local memory access instruction, which is different from the memory access instruction.

### BACKGROUND OF THE INVENTION

1. Field of the Invention

The invention relates to a cache memory unit that has a full-associative or set-associative cache memory body and supports an instruction execution unit that executes load instruction processing and store instruction processing on memory data.

2. Description of the Related Art

A so-called memory wall problem exists in an information processing system including High Performance Computing (HPC). High Performance Computing is a field of high speed computing or a field of technical computing which refers to a technical field of information processing apparatus having a high performance computing function. In the memory wall problem, the distance from a CPU to a memory is relatively increased as the number of generations increases.

In other words, the memory wall problem is a problem in which the improvements in speed of the entire system are maxing out since, because of advances in semiconductor technology, the improvements in the speed of DRAM or hard disk drives cannot keep up with the rapid improvements in the speed of a CPU. DRAM may be used in a main memory system while a hard disk drive may be used in an external memory system.

The memory wall problem appears in the form of memory access cost. Memory access cost has been widely recognized as a factor in the failure to obtain improvements in speed of the entire system commensurate to the improvements in the extent of parallelism of processing apparatus.

A cache memory mechanism exists as one resolution for the problem. A cache memory helps reduce the memory access latency.

On the other hand, since the existence of a cache memory unit is invisible to an instruction to be executed by a CPU, the lifetime of data in the cache memory is not controllable by software that describes a set of instructions.

In other words, software is generally created without being aware of the existence of a cache memory unit.

As a result, a situation may occur that data to be reused in the near future is purged from the cache memory before being reused.

Some applications have many operations that operate regularly, such as the execution of loop processing in a program. There are comparatively many cases in which data to be used in the near future can be identified through an analysis based on static information such as program codes.

This implies that a compiler can identify data and determine the period of the reuse of the data so that the period for keeping the data in a cache memory can be specified adequately to each level of cache memory in the memory hierarcky.

In other words, the number of accesses to the main memory is reduced by keeping specific data in a cache memory near a processor. Keeping specific data in a cache memory near a processor may reduce the data access cost more than before.

Presently, software is not allowed to perform such control, even if data kept in a cache memory once may no longer exist in the cache memory when an access request occurs thereto based on a subsequent instruction. An additional cost may thus be required for the data access.

Furthermore, a method may be conventionally adopted in which a special memory buffer is deployed near a processor core that performs operations.

The conventional method in which a special memory buffer is deployed has a problem in that the memory buffer may not be used flexibly without the addition of a special instruction. The special instruction may be necessary since the memory buffer is a hardware resource separately independent of a cache memory.

The conventional method in which a special memory buffer is deployed has another problem in that the performance is reduced as well upon execution of an application that is not suitable for the use of a memory buffer. The performance is reduced since the control is more complicated and the number of instructions increases more than those of methods not using a memory buffer. The number of instructions increases due to the intentional execution of the replacement of data based on a special instruction.

Furthermore, some applications may not be suitable for the use of a memory buffer. Therefore, in a case where either memory buffer or cache memory is to be used predominantly, the hardware resource with a lower frequency of use becomes redundant. This redundancy disadvantageously prevents the effective use of the hardware resource.

Here, a cache memory unit, particularly an HPC cache memory unit that can properly address target data has been demanded.

In other words, resolutions are demanded for problems including not only allowing data to be reused promptly as data in a cache memory, but also holding data to be reused in the long term for a period specified by software. For example, a cache memory may be used for a local memory as a memory buffer, which is a temporary area for register spill or loop division and to prevent unreusable data from purging reusable data.

### SUMMARY

In view of the problems, it is an object of a cache memory unit and control method according to the invention to place specific data near a processing apparatus for an intended period of time to allow access to the data upon occurrence of an access request for the memory data. It is an object of the invention to provide a cache memory unit and control method that can meet all of the demands for cache memory units, particularly HPC cache memory units, including not only allowing the use of data to be reused promptly as data in a cache memory, but also holding data to be reused in a long term for a period specified by software in a cache memory, to use a cache memory for a local memory as a memory buffer. A memory buffer is a temporary area for the register spill or loop division and to prevent unreusable data from purging reusable data, for example.

The object described above is achieved by a cache memory unit connecting to a main memory system having a cache memory area in which, if memory data that the main memory system has is registered therewith, the registered memory data is accessed by a memory access instruction that accesses the main memory system and a local memory area with which local data to be used by the processing section is registered and in which the registered local data is accessed by a local memory access instruction, which is different from the memory access instruction.

The above-described embodiments of the present invention are intended as examples, and all embodiments of the present invention are not limited to including the features described above.

### BRIEF DESCRIPTION OF THE DRAWINGS

FIG. 1 is a block diagram showing a configuration of an HPC cache memory unit according to a first embodiment;

FIG. 2 is a diagram illustrating a form of the division in an L1 (level-1) cache memory in the HPC cache memory unit according to the first embodiment;

FIG. 3 is a functional block diagram illustrating the switching configuration for function modes in the HPC cache memory unit according to the first embodiment;

FIGS. 4A and 4B are diagrams illustrating details of the definitions in an ASI-L2-CNTL register according to the first embodiment;

FIG. 5 is a configuration diagram illustrating a Reliability Availability Serviceability function of a local memory in the HPC cache memory unit according to the first embodiment;

FIG. 6 is a block diagram showing an outline of the configuration of a cache memory replace control section in an HPC cache memory unit according to a second embodiment; and

FIG. 7 is a flowchart illustrating operations by the cache memory replace control section in the HPC cache memory unit according to the second embodiment.

### DETAILED DESCRIPTION OF THE PREFERRED EMBODIMENTS

Reference may now be made in detail to embodiments of the present invention, examples of which are illustrated in the accompanying drawings, wherein like reference numerals refer to like elements throughout.

With reference to drawings, embodiments of the invention will be described below.

### First Embodiment

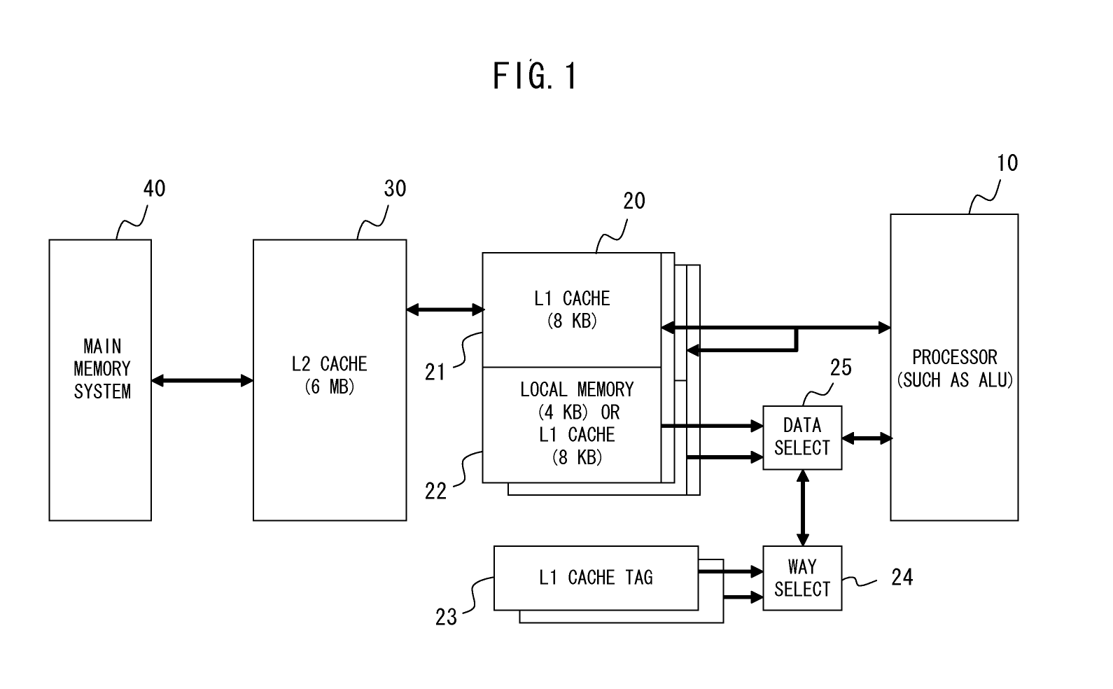

FIG. 1 is a block diagram showing a configuration of an HPC cache memory unit according to a first embodiment.

FIG. 1 is a diagram showing an HPC cache memory unit according to a first embodiment. In FIG. 1, an L1 (level-1) cache memory 20 of cache memories is shown in a multi-layered memory organization. The L1 cache memory 20 includes a high speed and small capacity SRAM (Static Random Access Memory or Static RAM) deployed near a processor 10. The L1 cache memory 20 is divided into a cache memory area 21 and a local memory area 22 functioning as a memory buffer.

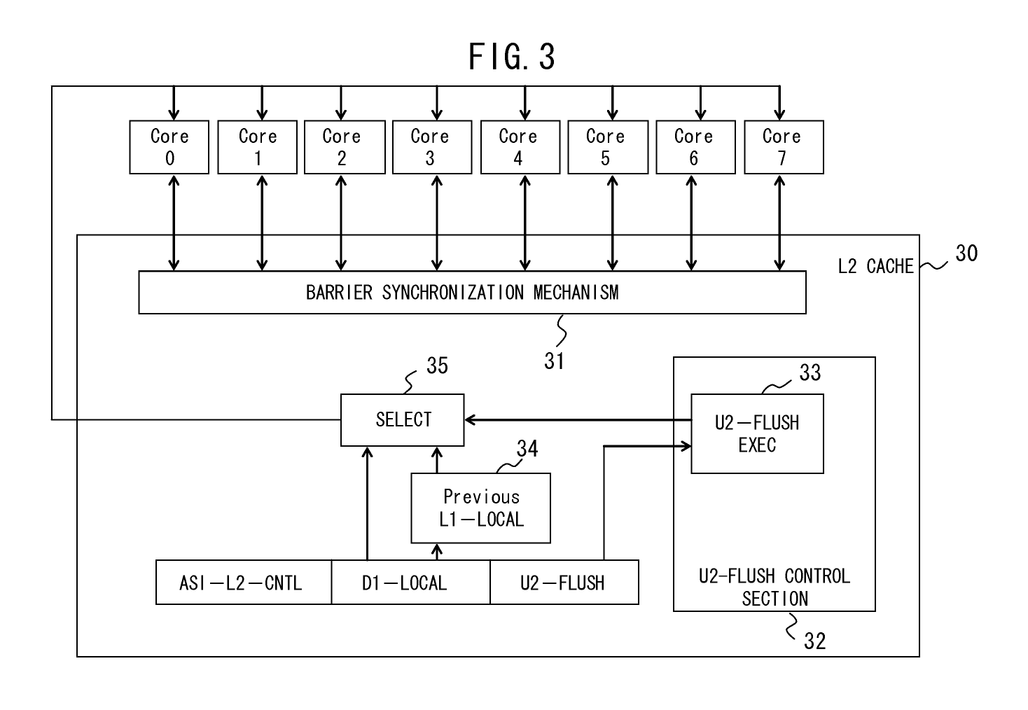

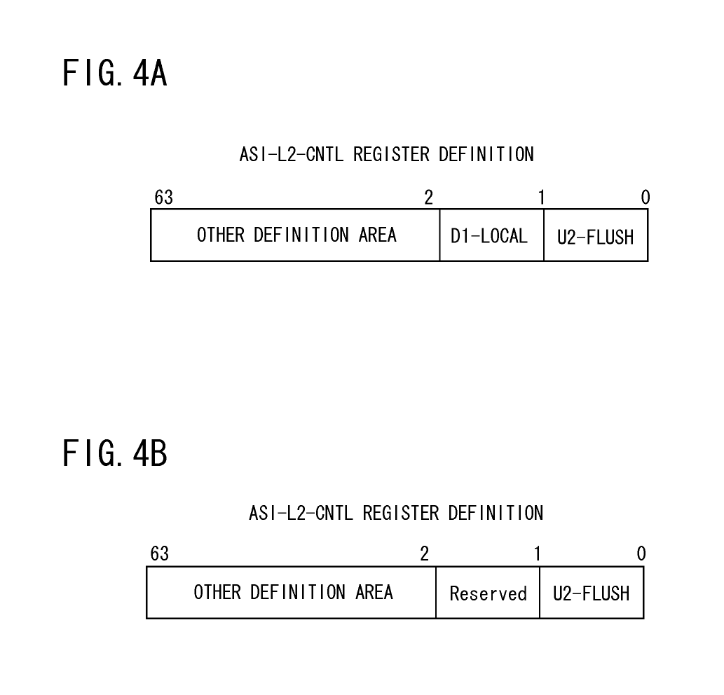

The details of the switching of function modes will be described later with reference to FIGS. 3 and 4A and 4B.

In this way, the HPC cache memory unit according to the first embodiment allows the parallel existence of the L1 cache memory area 21 and the local memory area 22 functioning as a memory buffer in the L1 cache memory 20.

FIG. 1 illustrates an HPC cache memory unit including a main memory system 40, an L2 (level-2) cache memory 30 of 6 MB capacity, and the L1 cache memory 20 in a 2-way configuration of a 16 KB capacity.

The cache memory area 21 in the HPC cache memory unit is 8 KB if half of the L1 cache memory 20 is assigned to the cache memory area 21. The remaining 8 KB are assigned to the local memory area 22 functioning as a memory buffer.

As an example of the multiplexing to be described later, 4 KB (which are equivalent to 512 8-byte registers) are finally assigned to the local memory area 22 in a mirroring configuration, since a RAS (Reliability Availability Serviceability) function is given to the assigned local memory area 22.

In general, an L1 cache tag 23 is used to check which area in the L1 cache memory 20 the target data of an access request exists upon receipt of the access request from the processor 10 to the memory. Then, a way select circuit 24 is used to select the_way, and the data selected by a data select circuit 25 according to the result of the way select circuit is output to the processor 10.

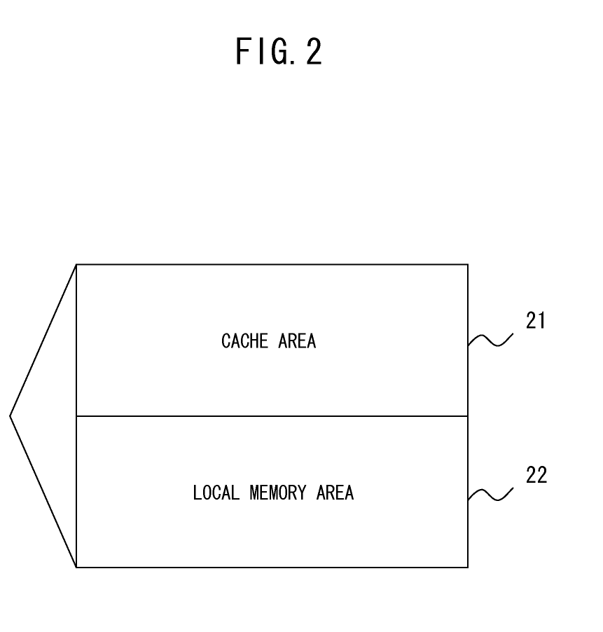

FIG. 2 is a diagram illustrating which divided area of the L1 cache memory is to be selected in the HPC cache memory unit according to the first embodiment.

Referring to FIG. 2, in a case where the assigned local memory area 22 is used as a local memory functioning as a memory buffer, the most significant bit of the address to be used for searches in the cache memory is used to select either cache memory area 21 or local memory area 22.

For example, in a case where the most significant bit has a value of zero, the cache memory area 21 is accessed. In a case where the most significant bit has a value of one, the local memory area 22 is accessed.

In this way, the HPC cache memory unit according to the first embodiment allows the parallel existence of a cache memory and a local memory functioning as a memory buffer. The HPC cache memory unit can support both of the configuration with a cache memory only and the configuration with the parallel existence of a cache memory and a local memory.

Furthermore, this HPC cache memory unit according to the first embodiment allows the parallel existence of a cache memory and a local memory without reduction of the number of ways of the cache memory.

The selection of a mode for operating on either cache memory only mode or parallel existence mode is controlled by designating a mode bit in a provided function mode register.

The switching of function modes is allowed under operating conditions of the system.

FIG. 3 is a functional block diagram illustrating the switching configuration of function modes in the HPC cache memory unit according to the first embodiment.

An HPC system having Processor Cores 0 to 7 in FIG. 3 performs a synchronous process among all of the processor cores. The cores, with the exception of one core, enter to a sleep state to terminate upon synchronization.

The synchronous process may be any synchronous process, such as one adopting a synchronization method using a memory area or a synchronization method using a hardware barrier mechanism.

FIG. 3 shows an example adopting a synchronization method using a hardware barrier mechanism 31.

The core that keeps operating after synchronization issues an SX-FLUSH instruction (which is an instruction that instructs ASI=0x6A disclosed in “SPARC JPS1 Implementation Supplement: Fujitsu SPARC64 V”), purges the data in the L2 cache memory 30 to the main memory system 40. The core then purges all of the data in the entire L1 cache memory 20 to create the state that the entire L1 cache memory is empty.

According to another embodiment, the state in which the entire L1 cache memory 20 is empty can be created by newly defining an instruction for purging the data in the entire L1 cache memory 20 to the L2 cache memory 30.

FIGS. 4A and 4B are diagrams illustrating details of the definitions in an ASI-L2-CNTL register according to the first embodiment.

FIG. 4A shows details of the definition in an ASI-L2-CNTL register according to the first embodiment, and FIG. 4B shows details of the definition in a conventional ASI-L2-CNTL register.

As shown in FIG. 4A, according to the first embodiment, the definition in the ASI-L2-CNTL register that receives the SX-FLUSH instruction is extended. A bit is added to the definition for instructing either occupation of the L1 cache memory 20 as a cache memory (D1-LOCAL=0) or parallel existence of the cache memory and the local memory for use (D1-LOCAL=1).

In the definition of the conventional ASI-L2-CNTL register shown in FIG. 4B, the bit corresponding to the D1-LOCAL is “Reserved” (meaning a reserved area) and is to be handled as “don't care” in decoding.

In other words, the conventional ASI-L2-CNTL register shown in FIG. 4B does not allow the selection of the parallel existence of a cache memory and a local memory for use.

Here, in a case where the U2-FLUSH bit in FIG. 4A is on and a U2-FLUSHEXEC state indicator 33 indicates ON where the U2-FLUSHEXEC state indicator 33 indicates the state during the execution of the SX-FLUSH instruction by a U2-FLUSH control section 32 in FIG. 3, a Previous L1-LOCAL register 34, which is the value before the execution of the SX-FLUSH instruction, is used as a valid value.

In other words, in a case where the U2-FLUSH bit is on, the value indicated by the Previous L1-LOCAL register 34 is determined as valid and is used by a select section 35 before the execution of the SX-FLUSH instruction by the U2-FLUSH control section 32 in FIG. 3. After the completion of the SX-FLUSH instruction, the value of the L1-LOCAL register instructed upon issue of the SX-FLUSH instruction is determined as valid and is used by the select section 35.

In this way, the L1 cache memory is cleared, and the function modes are switched after the completion of the clear of the L1 cache memory.

Furthermore, by setting the value of the D1-LOCAL in FIG. 4A to 0 or 1, the operations by all of the cores are restarted by the synchronization mechanism after the completion of the switching of the function modes of the L1 cache memory.

As described above, in the HPC cache memory system according to the first embodiment, in a case where a function mode switching instruction is issued during operation of the system, the instruction being executed is interrupted, and the entire data in the L1 cache memory is invalidated, keeping cache coherence, to create the empty state of the L1 cache memory.

After that, by rewriting the value of the ASI-L2-CNTL register, which is the setting register for a function mode, either configuration with a cache memory only or configuration with the parallel existence of a cache memory and a local memory is defined. Then, upon completion of the switching of the function modes, the execution of the instruction being interrupted is restarted.

Thus, the adoption of the parallel existence with a local memory can be switched during operation of the system without rebooting the system.

The function mode bit is defined not in cores but in processors where one processor has multiple processor cores.

Thus, in memory access between processor cores and a cache memory shared by the processor cores, a uniform address can be used for the coherence control over the cache memory, and the L1 cache memory can be managed easily from the L2 cache memory side.

In a case where the configuration with the parallel existence of a cash memory and a local memory is set by the ASI-L2-CNTL register, which is the setting register for a function mode, a local memory area functioning as a memory buffer is accessed in response to a newly defined load or store instruction.

Next, the RAS function of a local memory in the HPC cache memory system according to the first embodiment will be described.

A local memory according to the first embodiment must correct a 1-bit failure (or error) in a local memory area with data in a local memory area since no copy of data is left in another memory level.

Then, according to the first embodiment, a local memory area is divided into two areas as shown in FIG. 1, and data is mirrored by storing identical data to the memory areas.

In a local memory according to the first embodiment, the mechanism of an unused cache tag is diverted to the error management for access to the right data always from the mirrored data.

In general, a cache tag has an address in the main memory system of a cache memory and a valid bit indicating the validity of cache data.

Accordingly, in the local memory according to the first embodiment, it is regarded that the local memory stores the valid value in a case where the valid bit indicating the validity of the data in the cache memory is on.

In a case where an error occurs in the local memory, the valid bit of the tag corresponding to the data having the error is turned off, and the subsequent access to the local memory is controlled so as not to select the data corresponding to the tag with the valid bit off.

Notably, if the number of ways of a cache memory is three to N areas (where N is a positive integer), the local memory area can be three-plexed to N-plexed to use.

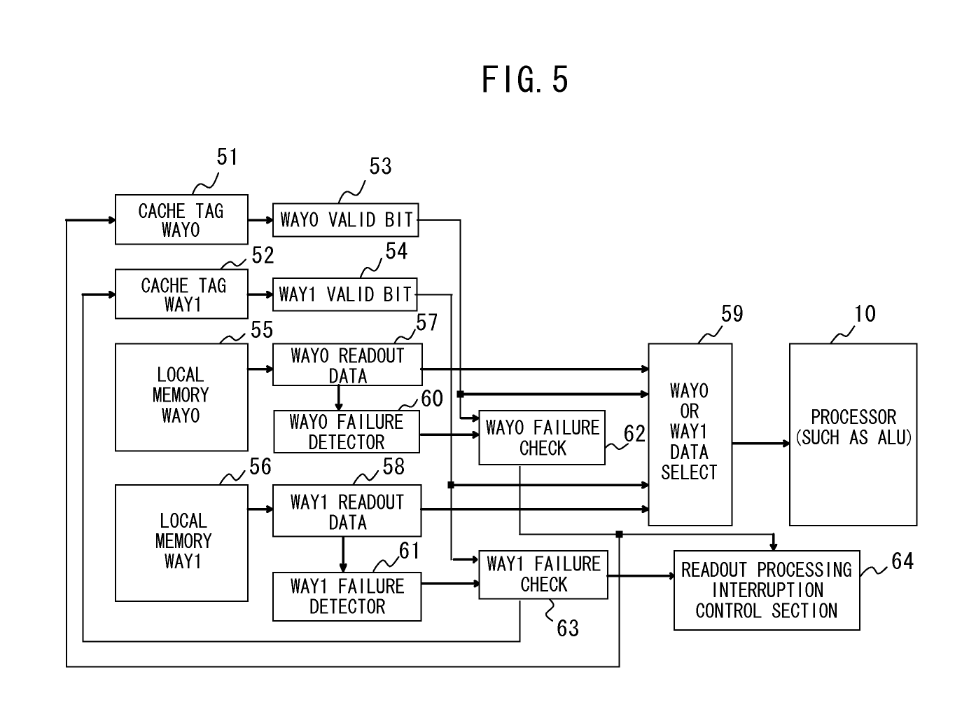

FIG. 5 is a configuration diagram illustrating the RAS function of a local memory in the HPC cache memory unit according to the first embodiment.

In FIG. 5, a cache tag WAY0 51 and a cache tag WAY1 52 have fields for storing a status bit indicating the status of a corresponding cache line and address information in the main memory of the cache line.

The status bits are valid bits 53 and 54 indicating that the cache line is valid. The local memory regards the data with the valid bit on as valid information.

In a case where writing is performed to the local memories 55 and 56 on the WAY0 and WAY1, the valid bits 53 and 54 are turned on, and the cache tags 51 and 52 for the WAY0 and WAY1 are updated.

In this case, the valid bits 53 and 54 of the cache tags 51 and 52 for both of the WAY0 and WAY1 are turned on, and one same value is written to the local memories 55 and 56 for the WAY0 and WAY1.

In order to read out the local memories 55 and 56 on the WAY0 and WAY1, the cache tags 51 and 52 are searched, and readout data 57 and 58 on the areas with the valid bits 53 and 54 on are selected by a select section 59.

In general, both of the valid bits 53 and 54 are turned on, the data 57 and 58 in both areas are selected.

Here, the details of the data 57 and 58 in both areas are identical, it is no problem that the select section 59 may select multiple data pieces.

In a case where both of the data 57 and 58 in both areas are selected, a different control method (not shown) may control to select one area only.

The data read out from the local memories 55 and 56 have failure detection mechanisms 60 and 61, each of which detects an error in the data before an area or areas are detected.

In a case where the local memories 55 and 56 are read out and the failure detection mechanisms 60 and 61 detect a data failure and if the valid bits of the corresponding areas are on, a readout processing interruption control section 64 interrupts the readout processing through failure check mechanisms 62 and 63, and the valid bits 53 and 54 of the cache tags 51 and 52 for the failure detected areas are rewritten to the off state.

After that the interrupted readout processing is restarted.

Thus, the data (57/58) in the area having an error is excluded from the targets of the failure detection and from the targets of the access in accessing the local memory (55/56) since the valid bit (53/54) of the cache tag (51/52) is off.

Under this control, the access to the data having an error is excluded in a local memory functioning as a memory buffer, and the data having an error and being abnormal can be accessed, which allows keeping operations even upon occurrence of the error.

### Second Embodiment

An HPC cache memory unit according to a second embodiment can execute the cache line replace control (cache line replace lock) over a set-associative cache memory without overhead.

In general, in order to register new data with a set-associative cache memory, all of the number of areas of a target entry may already have been used.

In order to allocate the line for registering data in this case, control must be performed to purge an existence cache line to a lower cache memory or the main memory system. This is called “cache line replace”.

Either LRU (Least Recently Used) method or round robin method is generally adopted as the algorithm for selecting a cache line to be replaced.

In LRU method, an LRU bit is provided to each line of a cache memory, and the LRU bit is updated during every access to the line.

More specifically, in the cache line replace, the LRU bit is updated such that the cache line which has not been accessed for the longest period of time can be replaced.

The HPC cache memory unit according to the second embodiment is controlled by executing memory access instructions (or instruction set), which are newly provided for executing the cache line replace control, as in:

[a] Instruction to exclude an applicable cache line from replace targets (cache line lock instruction), and

[b] Instruction to include an applicable cache line into replace targets (cache line unlock instruction)

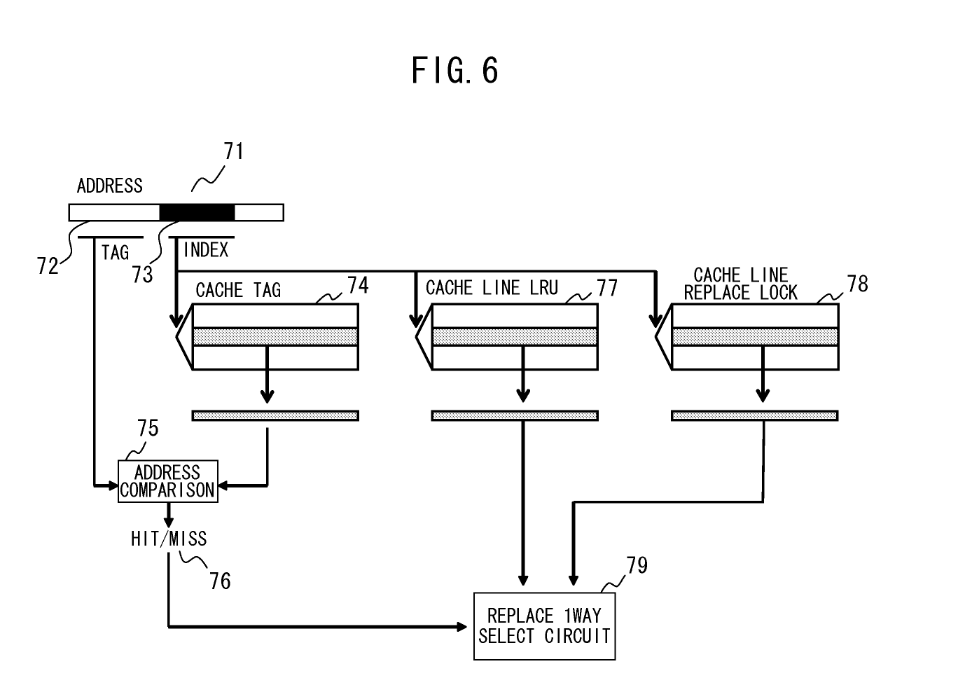

A cache line replace lock table 78 is provided as a table that holds the lock/unlock states of cache lines based on the instructions [a] and [b]. The cache line replace lock table 78 holds the lock/unlock information of each area of all entries of the cache memory shown in FIG. 6, which will be described later.

FIG. 6 is a block diagram showing an outline of the configuration of a cache line replace control section in the HPC cache memory unit according to the second embodiment.

Referring to FIG. 6, upon occurrence of an access request to memory data, tables of a cache tag table 74, a cache line LRU table 77 and the cache line replace lock table 78 are accessed based on index information 73 created from the address 71 of the memory data, and the information of the entry is read out.

The information read out from the cache tag table 74 and the information of the tag section 72 of the address 71 are compared in address by an address comparing section 75, and the hit/miss 76 of the cache memory is determined.

If the miss is determined, the vacancies of the areas of the entry are checked in order to store new data.

If no area is vacant, a replace request to an existing cache line is issued to a replace 1way select circuit 79.

The replace 1way select circuit 79 selects and regards as a replace target the area of the cache memory line with “replace lock on” and “unused for the longest period of time” based on the information read out from the cache line LRU table 77 and the cache line replace lock table 78.

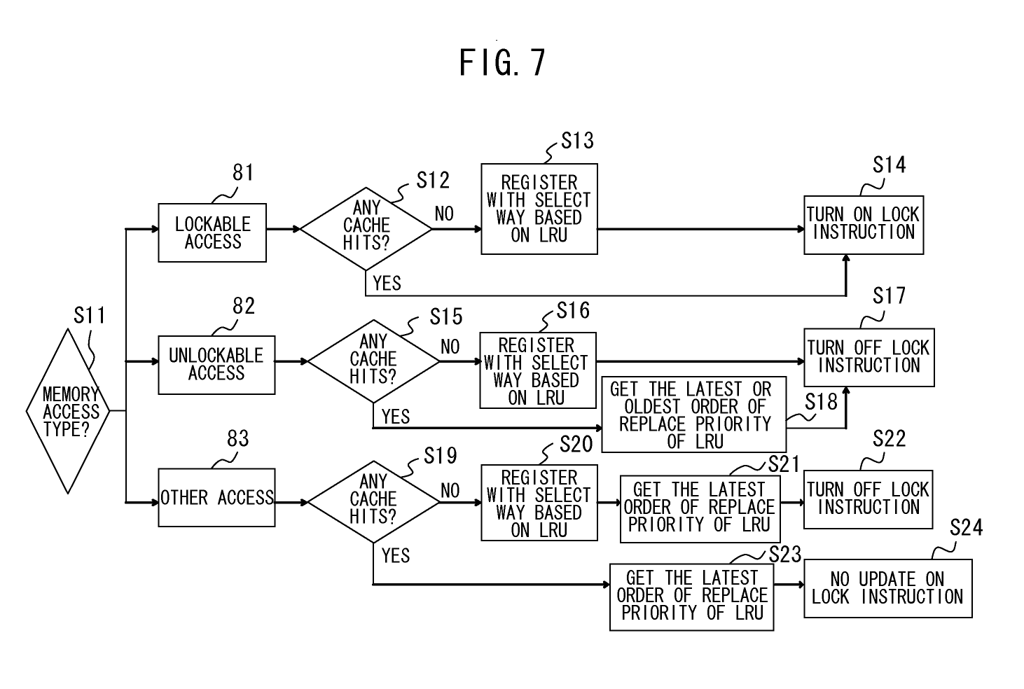

FIG. 7 is a flowchart illustrating operations by the cache memory replace control section in the HPC cache memory unit according to the second embodiment.

In operation S11 first of all, the type of memory access is determined.

If the memory access is a lockable access 81 as a result of the determination in operation S11, either cache hit or not is determined in operation S12.

If the cache miss occurs as a result of the execution of the memory access instruction with the cache line lock by [a], the new data read out from the main memory system is registered with the cache line of the area selected by the select operation in the replace area candidates in operation S13. Then, in operation S14, the replace lock of the cache line is turned on.

If the cache hit is determined, the replace lock of the line with the cache hit is turned on in operation S14.

If the memory access is an unlockable access 82 as a result of the determination in operation S11, either cache hit or not is determined in operation S15.

If the cache miss occurs as a result of the execution of the memory access instruction with the cache line unlock by [b], new data read out from the main memory system is registered with the cache line of the area selected by the replace candidate select operation in operation S16. Then, in operation S17, the replace lock of the cache line is turned off.

If the cache hit occurs, the LRU bit is updated as the oldest accessed state in operation S18, and the replace lock of the cache line with the cache hit is turned off in operation S17.

A function of registering as the latest access state is also provided for changing the order of priority of LRU bits.

The switching may be performed in a fixed manner by hardware, or one state may be selected by software.

If the memory access is an access 83, which is not the lockable access 81 or the unlockable access 82, as a result of the determination in operation S11, either cache hit or not is determined in operation S19.

If the cache miss occurs as a result of the execution of a memory access instruction, which is not the memory access instruction with the cache line lock by [a] or the memory access instruction with the cache line unlock by [b], the new data read out from the main memory system is registered with the cache line of the area selected by the replace candidate select operation in operation S20. Then, in operation S21, the LRU bit is updated as the latest accessed state. In operation S22, the replace lock of the cache line is turned off.

If the cache hit occurs and if the replace lock is off, the LRU bit is updated as the latest accessed state in operation S23. In operation S24, the replace lock of the line with the cache hit is returned to the same state as that before the access.

However, if the state of the replace lock is on before the access, the state of the LRU bit may be updated as the same state as that before the access.

In this way, the HPC cache memory unit according to the second embodiment performs the replace control over a cache memory by using the newly provided cache memory line lock instruction and cache line unlock instruction. However, in the replace control over cache memories, the replace control over the cache areas and cache lines by the LRU algorithm can be performed as conventional without overhead based on the information read out from the cache memory LRU table and the cache line replace lock table.

The implementation of this embodiment particularly can be changed without a heavy load since there are no changes in data paths.

### Third Embodiment

It is difficult to use a cache memory as intended by estimating the behavior of the cache memory by software because hardware determines the area to register data.

(Apparently, in a business application in which the pattern for accessing a memory cannot be identified, the method in which hardware determines a replace target by the LRU algorithm is the best way from the viewpoint of the efficiency of use of a cache memory).

However, the LRU algorithm may not be the best in a case where the reusability of data can be statically determined from the program code upon compilation.

In other words, since the LRU algorithm does not consider the reusability that can be determined from the program code upon compilation, data without reusability may remain in a cache memory. The cache line with a higher probability of reuse in the near future, which should be actually held in the cache, may be determined as a replace target in some cases.

In order to avoid this and keep a data area with a higher reusability in a cache memory and to determine data without reusability as a replace target, an HPC cache memory unit according to a third embodiment includes selecting, by software, the cache area to be used for the registration of a new cache line.

The cache area to register data and the address of the data to be registered are selected, and an instruction for performing prefetch to the cache area is newly defined.

Like the prefetch instruction, an instruction for selecting the area to register data can be newly defined also for the load instruction or store instruction.

Furthermore, data without reusability can be registered with a selected area through the prefetch instruction by predetermining that software handles one area of multiple areas as the cache area to be replaced with high priority.

In other words, the area to register with a cache memory is selected upon issue of the load instruction or store instruction.

This can be implemented by providing the instruction set to the function of selecting an area.

Then, if the cache miss occurs, data is registered with the cache line of the area selected by the load instruction or store instruction. The data is registered by ignoring the LRU bit, though the replace control is generally performed based on the LRU bit.

Thus, the operation can be avoided in which data without reusability unintentionally purges reusable data registered with a different area.

On the other hand, the continuous registration of once registered data with a cache (or in cache) can be secured by prefetch and registering data which needs to be held in a cache memory with a selected area and preventing the prefetch that selects the same area to the data at an address related to that of the data after that.

In other words, the HPC cache memory unit according to the third embodiment allows control over a cache memory from viewpoint of software by explicitly selecting the area of a cache memory and can implement a pseudo local memory as a memory buffer.

### Fourth Embodiment

An HPC cache memory unit according to a fourth embodiment is a variation of the HPC cache memory unit according to the third embodiment and includes controlling the replacement of a cache memory by software, which is different from that of the HPC cache memory unit according to the third embodiment.

In other words, the HPC cache memory unit according to the fourth embodiment includes a register that selects a replacement-inhibited cache area, and the register is determined as a target of the cache memory area lock by software to limit the area available to the load instruction or store instruction or the prefetch instruction.

The cache line to the area unused by the load instruction or store instruction or the prefetch instruction is registered by selecting the cache memory area to be used for the registration of a new cache line by software.

Thus, the load instruction or store instruction or the prefetch instruction that does not select the cache memory area to be used for the registration of a new cache line can avoid the replacement of the data even when the cache miss occurs.

Therefore, while software must control all cache misses in order to keep data in cache by using the HPC cache memory unit according to the third embodiment, software does not have to control all cache misses according to the fourth embodiment.

The cache line lock function can be operated correctly over not only the cache miss on an operand such as data but also the cache miss on an instruction string.

Having described the set-associative cache memories only, for example, the HPC cache memory unit according to this embodiment is applicable to a full-associative cache memory.

A full-associative cache memory is a cache memory applicable in a special case of the set-associative method and has a structure in which all of lines are available for searches without the division based on entry addresses and in which the degree of association depends on the number of lines.

A cache memory unit according to the embodiment can meet the demands for HPC cache memory units. For example, data to be reused shortly can be held in a cache memory for use as normal. In addition, the data to be reused for a longer period of time can be used as a cache data for a period specified by software.

Furthermore, the cache memory functioning as a memory buffer, which is a temporary area for register spill or loop division, can be used as a local memory.

Still further, data without reusability does not purge data with reusability.

Although a few preferred embodiments of the present invention have been shown and described, it would be appreciated by those skilled in the art that changes may be made in these embodiments without departing from the principles and spirit of the invention, the scope of which is defined in the claims and their equivalents.

What is claimed is:

1. A cache memory unit connecting to a main memory system and internally contained in a processing apparatus having a processing section that performs processing, the cache memory unit comprising:
a cache memory area in which, if memory data that the main memory system has is registered therewith, the registered memory data is accessed by a memory access instruction that accesses the main memory system; and
a local memory area with which local data to be used by the processing section is registered and in which the registered local data is accessed by a local memory access instruction, which is different from the memory access instruction.

2. The cache memory unit according to claim 1, wherein the address for accessing the cache memory area and the address for accessing the local memory area are distinguished based on the most significant bit of each of the addresses.

3. The cache memory unit according to claim 1, wherein the local memory area is mirrored.

4. The cache memory unit according to claim 1, further comprising:
a cache tag having a valid bit indicating the validity of the local data registered with the local memory area.

5. The cache memory unit according to claim 1, wherein:
the cache memory area has multiple cache areas each having multiple cache lines with which data are registered; and
each of the multiple cache lines of the multiple cache areas is locked by a first instruction that excludes a cache line with which data is registered from replace targets and is unlocked by a second instruction that includes the cache line with which data is registered in the replace targets.

6. The cache memory unit according to claim 5, wherein the memory access instruction selects a cache area to register memory data that the main memory system has in order to register the memory data with the cache line of the cache memory area.

7. The cache memory unit according to claim 5, further comprising a register that selects a cache area to be excluded from the replace targets.

8. A processing apparatus connecting to a main memory system, the apparatus comprising:
a processing section that performs processing;
a cache memory unit having a cache memory area in which, if memory data that the main memory system has is registered therewith, the registered memory data is accessed by a memory access instruction that accesses the main memory system and a local memory area with which local data to be used by the processing section is registered and in which the registered local data is accessed by a local memory access instruction, which is different from the memory access instruction.

9. The processing apparatus according to claim 8, wherein, in the cache memory unit, the address for accessing the cache memory area and the address for accessing the local memory area are distinguished based on the most significant bit of each of the addresses.

10. The processing apparatus according to claim 8, wherein, in the cache memory unit, the local memory area is mirrored.

11. The processing apparatus according to claim 8, the cache memory unit further having:
a cache tag having a valid bit indicating the validity of the local data registered with the local memory area.

12. The processing apparatus according to claim 8, wherein, in the cache memory unit:
the cache memory area has multiple cache areas each having multiple cache lines with which data are registered; and
each of the multiple cache lines of the multiple cache areas is locked by a first instruction that excludes a cache line with which data is registered from replace targets and is unlocked by a second instruction that includes the cache line with which data is registered in the replace targets.

13. The processing apparatus according to claim 12, wherein, in the cache memory unit, the memory access instruction selects the cache area to register memory data that the main memory system has in order to register the memory data with the cache line in the cache memory area.

14. The processing apparatus according to claim 12, the cache memory unit further having a register that selects a cache area to be excluded from the replace targets.

15. The processing apparatus according to claim 8, comprising:
multiple processing sections; and
a synchronization control section that performs a synchronous process between or among the multiple processing sections and, upon completion of the synchronous process, terminates the processing sections excluding one processing section between or among the multiple processing sections.

16. A control method for a processing apparatus connecting to a main memory system and having a processing section that performs processing and a cache memory unit having a cache memory area and a local memory area, the method comprising:
registering memory data that the main memory system has with the cache memory area;
accessing the memory data registered with the cache memory area by using a memory access instruction that accesses the main memory system;
registering local data to be used by the processing section with the local memory area; and
accessing the local data registered with the local memory area by using a local memory access instruction, which is different from the memory access instruction.

17. The control method for the processing apparatus according to claim 16, in which, in the cache memory unit:
the cache memory area has multiple cache areas each having multiple cache lines with which data are registered,
the control method for the processing apparatus, further comprising:
locking by a first instruction that excludes a cache line with which data is registered from replace targets; and
unlocking by a second instruction that includes the cache line with which data is registered in the replace targets.

18. The control method for the processing apparatus according to claim 17, further comprising selecting, by the memory access instruction, the cache area to register memory data that the main memory system has in order to register the memory data with the cache line in the cache memory area.

19. The control method for the processing apparatus according to claim 17, in which the cache memory unit further has a register, the method further comprising:
selecting a cache area to be excluded from the replace targets.

20. The control method for the processing apparatus according to claim 16, in which the processing apparatus has multiple processing sections,
the method further comprising
performing a synchronous process between or among the multiple processing sections;
terminating the processing sections upon completion of the synchronous process; and
excluding one processing section between or among the multiple processing sections.
